(19) United States
(12) Patent Application Publication
(10) Pub. No.: US 2015/0191872 A1
(43) Pub. Date: Jul. 9, 2015

(54) SEALING STRIP

(71) Applicant: VOITH PATENT GMBH, HEIDENHEIM (DE)

(72) Inventors: Marc Erkelenz, Ulm (DE); Jochen Honold, Schlingen (DE)

(21) Appl. No.: 14/422,027

(22) PCT Filed: Aug. 9, 2013
(86) PCT No.: PCT/EP2013/066694

§ 371 Date: Feb. 17, 2015

(30) Foreign Application Priority Data
Aug. 15, 2012 (DE) 10 2012 214 525.7
Oct. 11, 2012 (DE) 10 2012 218 532.1

(51) Int. Cl. D21F 7/00; F16J 15/16

(52) U.S. Cl. CPC D21F 7/00; F16J 15/162

(57) ABSTRACT

A sealing strip for sealing at least one suction box which adjoins a moving roller sleeve of a suction roller in a machine for manufacturing or processing a fibrous web, such as a paper, tissue, or cardboard-making machine, bears in a sealing manner on the moving roller sleeve. In the region of the at least one sealing strip and/or on the at least one sealing strip and/or in the at least one sealing strip a device for deploying a lubricant which wets the at least one sealing strip is in each case provided. The at least one sealing strip is provided with a lubricant sump which is open counter to a rotation direction of the moving roller sleeve and is connected to the lubrication device. A contamination guard is provided in the lubricant sump.

The invention relates to a sealing strip, in particular for use in a suction roller of a machine for manufacturing a fibrous web, such as a paper, cardboard, or tissue web, according to the preamble of claims 1, 6, 9, 13, and 16.

In machines for manufacturing paper, cardboard, or tissue, suction rollers which have the task of drawing water from the respective fibrous web and/or of guiding the fibrous web are used in various positions. The suction rollers usually display a stationary suction box having one or a plurality of vacuum zones and a roller sleeve which rotates above the suction box. The suction box is sealed in relation to the interior space of the roller by means of sealing strips. Per suction box there are thus at least two sealing strips, or else a plurality thereof in the case of a plurality of separate negative- or positive-pressure zones.

Present-day sealing strips typically are composed of soft materials, such as graphite or a graphite-rubber mixture, for example. Since the sealing strips are in tribological contact with the roller sleeve and, on account thereof, experience abrasion, adequate lubrication which ensures functioning of the sealing strips has to be provided. According to the prior art, the sealing strips are usually lubricated by an external injection pipe which is disposed so as to be on the supply side of the leading sealing strip. The lubricant applied thereonto migrates to the downstream sealing strips by the rotation of the roller sleeve. A sealing strip of this type is disclosed in EP 1 350 890 A, for example.

Recently, systems which for reasons of space are configured so as to be integrated in the sealing strips have additionally been developed for lubricating the sealing strips.

In order to alleviate the disadvantages which result from the use of a single lubricant supply for a plurality of sealing strips, lubrication systems for sealing strips which assign a dedicated lubricant supply to each individual sealing strip have been developed. On account thereof, issues such as excessive sealing-strip wear and consequential collapsing of the vacuum and potential web rupturing with consequential machine stoppages can be avoided.

However, non-uniform distribution of lubricant across the length of the sealing strip in the machine cross direction due to non-uniform or fluctuating lubricant pressure or volumetric flow which in regions may cause insufficient lubrication of the sealing strip while too much lubricant is made available in other regions, on account of which lubricant transgression through the suction bores into the fibrous web and thus a non-uniform transverse moisture profile may arise, remains disadvantageous here in the case of the afore-described sealing-strip systems.

The tendency of the sealing strips toward contamination is also an issue which has not yet been satisfactorily solved. On account of suctioning water from the fibrous web, fibers and additives from the material make their way through the suction bores of the suction roller into the interior and are partly scraped off the roller sleeve by the sealing strips. The fibers and additives may consequently be deposited on the sealing strips, this in turn preventing uniform deployment of the lubricant across the entire length of the sealing strip.

It is thus an object of the invention to state a sealing strip which avoids or at least mitigates the mentioned disadvantages.

The object is achieved by the characterizing features of claims 1, 6, 9, 13, and 16, in each case in conjunction with the generic features.

According to one preferred embodiment, it may be provided that a contamination guard is provided in the lubricant sump.

According to a further preferred embodiment, supply ducts which are configured in the sealing strip and which are connected to the lubricant distributor duct may display variable diameters. On account thereof, it is possible to achieve pressure adjustment in the machine cross direction, which in turn homogenizes the lubricant supply.

According to a further advantageous embodiment of the invention, it may be provided that supply ducts which are configured in the sealing strip and which are connected to the lubricant distributor duct display variable spacings from one another.

A further preferred exemplary embodiment may provide that supply ducts which are configured in the sealing strip and which are connected to the lubricant distributor duct open out from the sealing strip in at least two rows which are substantially parallel with one another.

Furthermore preferable is a variant of design embodiment in which it is provided that supply ducts which are configured in the sealing strip and which are connected to the lubricant distributor duct open out into fan-type clearances in the surface of the sealing strip.

Further preferred exemplary embodiments and advantageous aspects of the invention are derived from the dependent claims.

According to one advantageous aspect of the invention, the contamination guard may be configured so as to be channel-shaped and in a continuous manner or with interruptions extend substantially across the entire length of the sealing strip.

It is furthermore advantageous for the contamination guard to be disposed such that it substantially forms the lowest point of the lubricant sump.

Preferably, the lubricant sump may be connected to the means by way of at least one supply duct, preferably by way of a plurality of supply ducts.

According to a further preferred aspect of the invention, it may be provided that a spacing between an overflow edge of the sealing strip and the roller sleeve is always greater than 0.

Preferably, the diameter of the supply ducts may depend on the spacing of the latter from the at least one lubricant supply.

It is furthermore advantageous for the diameter of the supply ducts to be smallest in the region of the inlet of the at least one lubricant supply into the lubricant distributor duct and to increase as the distance to the at least one lubricant supply grows.

Advantageously, the spacing of the supply ducts may be equal or unequal.

Preferably, the spacing of the supply ducts may be between 0.5 and 500 mm.

Particularly preferably, the supply ducts may display a conical shape in the longitudinal section, which conical shape widens from an outlet out of the lubricant distributor duct to an outlet out of the sealing strip.

According to a further advantageous embodiment, it may be provided that the supply ducts of the at least two rows open out into pockets which are incorporated in a surface of the sealing strip.

At least one supply duct may open out into each of the pockets.

Preferably, the fan-type clearances may widen and/or flatten in an outlet direction of the sealing strip.

Advantageously, at least one supply duct may open out into each of the fan-type clearances.

The invention is explained in more detail in an exemplary manner in the following with reference to the figures, in which:

FIG. 1 shows, highly schematically, an illustration of a first exemplary embodiment of a sealing strip, having measures according to the invention, in a lateral sectional view,

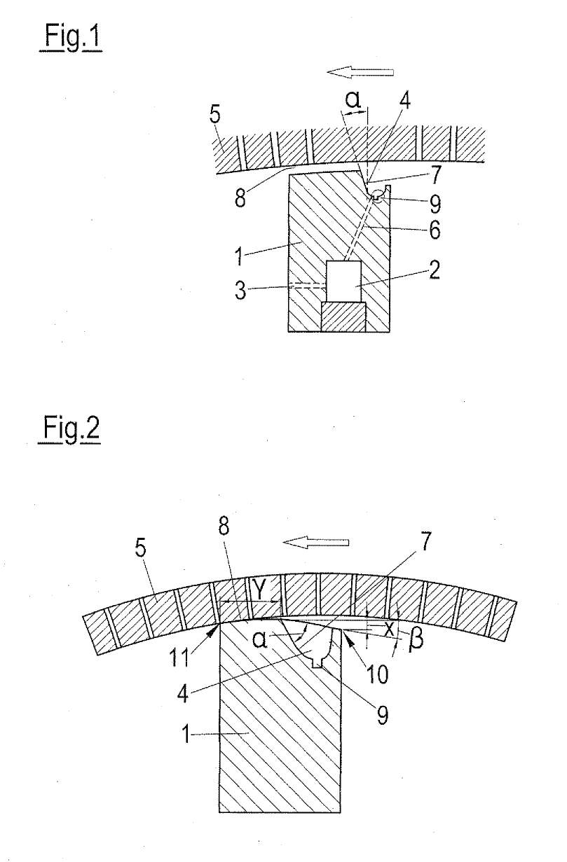

FIG. 2 shows, highly schematically, a larger illustration of the first exemplary embodiment of the sealing strip according to FIG. 1,

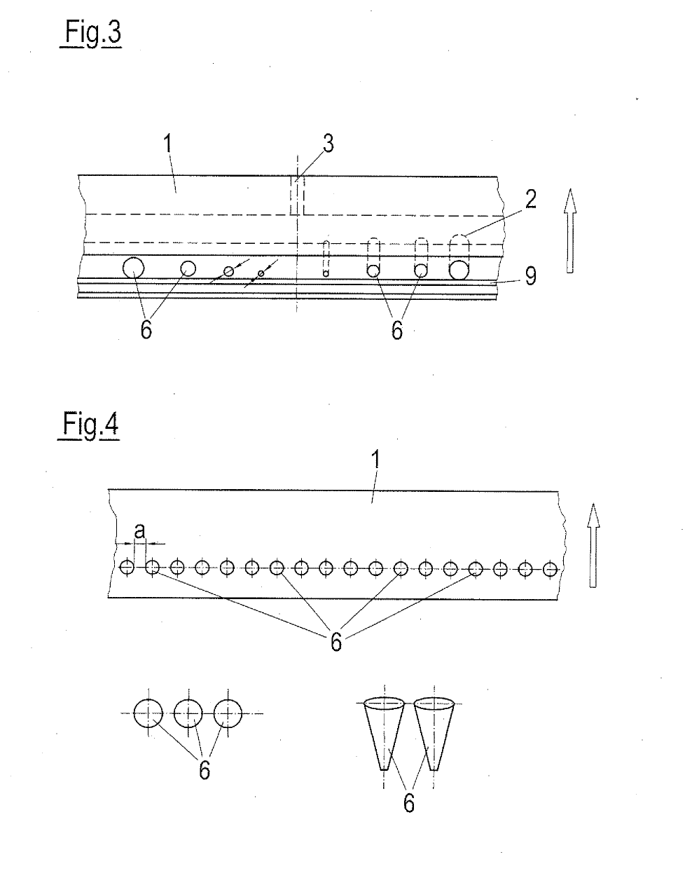

FIG. 3 shows, highly schematically, an illustration of a second exemplary embodiment of a sealing strip configured according to the invention, in a plan view,

FIG. 4 shows, highly schematically, an illustration of a third exemplary embodiment of a sealing strip configured according to the invention, in a plan view,

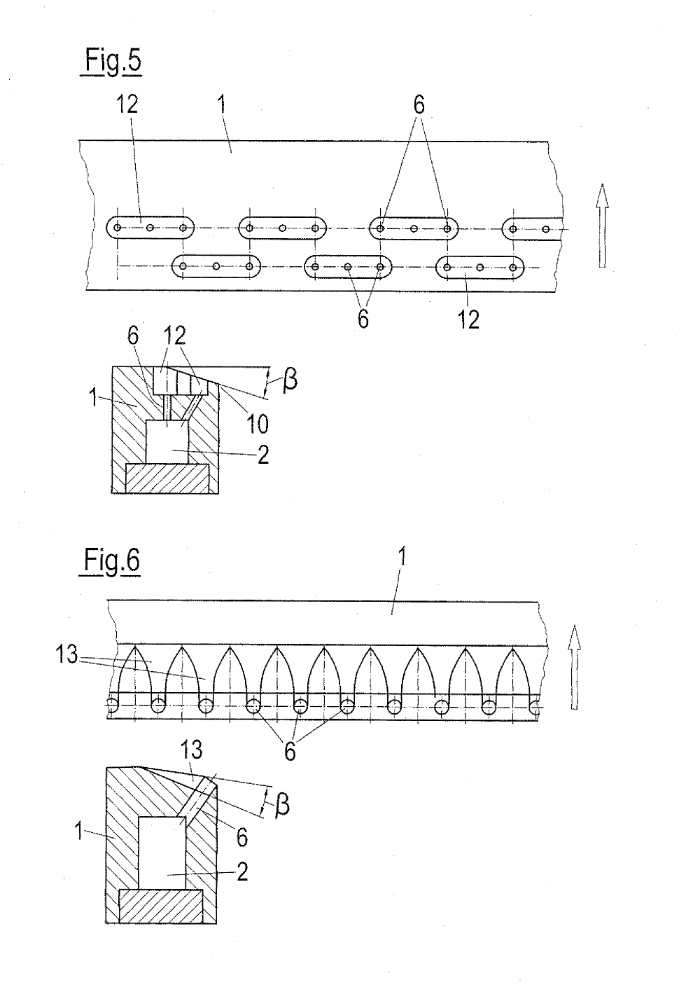

FIG. 5 shows, highly schematically, an illustration of a fourth exemplary embodiment of a sealing strip configured according to the invention, in a plan view, and

FIG. 6 shows, highly schematically, an illustration of a fifth exemplary embodiment of a sealing strip configured according to the invention, in a plan view.

In FIG. 1, a sealing strip 1 for use in a suction roller for a machine for manufacturing or processing a fibrous web, such as a paper, cardboard, or tissue web, is illustrated in a schematic manner. Suction rollers of this type here usually display a perforated roller sleeve 5, which is rotatably mounted, and in the interior of the suction roller a stationary suction box. Since the mentioned components are in the prior art, a detailed illustration and description can be dispensed with at this point.

The suction box serves for generating a vacuum which, through perforations which exist in the roller sleeve 5, suctions off fluid from the fibrous web and in this manner increases the dry content of the fibrous web. Furthermore, the vacuum in many suction positions is employed for deflecting and guiding the fibrous web.

The suction box commonly displays at least two sealing strips 1 which extend across the length of the suction box in the machine cross direction, seal the suction box in relation to an interior space of the suction roller and in this manner enable the vacuum which is required for dewatering or guiding the fibrous web to be maintained. The sealing strips here bear tightly on an inner face of the roller sleeve 5 which rotates above the stationary suction box.

On account of their positioning and the tribological contact with the rotating roller sleeve 5, the sealing strips 1 are subject to heavy stress which manifests itself in particular in a high rate of abrasion and a strong tendency toward contamination. The consequences of wear and contamination are disturbances of the vacuum, such as drawing leak air, for example, which consequently may lead to web rupturing and to cost-intensive machine stoppages.

Various approaches to reducing abrasion are known, for example by way of selecting particularly abrasion-resistant materials. A further measure which provides a remedy here is the delivery of lubricant, in particular water, to the sealing strips 1, such that a lubricating film is configured between the sealing strip 1 and the inner face of the roller sleeve 5. Lubrication here may take place by supply via injection pipes and/or via lubrication ducts which are integrated in the sealing strips 1.

The contaminants which are deposited in the region of the sealing strip 1 are mainly formed by fibers from the fibrous web, which are suctioned off and make their way via the openings in the suction roller sleeve into the interior thereof, and by the additives in the fiber suspension.

These deposits may likewise lead to leak air and disturbances in the vacuum, in particular when the lubricant-water supply is disturbed by accumulations of contaminants.

In the following, therefore, various measures for reducing the tendency toward contamination of the sealing strips 1 which make for a uniform lubricant supply to the sealing strips 1 and reduce or even prevent the tendency toward depositions of contaminants, or enable reliable removal of said depositions of contaminants, are stated.

In FIG. 1 a first exemplary embodiment of a sealing strip 1 which comprises measures for the reduction of contaminants is illustrated. The sealing strip 1 here is shown in a sectional illustration, wherein the cut line is placed in the machine direction and the viewing direction thus runs in the machine cross direction.

The sealing strip 1 displays a lubricant-water distributor duct 2 which runs in the sealing strip 1 and is fed by lubricant-water supplies 3. One or a plurality of lubricant-water supplies 3 may exist per sealing strip 1. In a run-up side of the sealing strip 1 a channel-type lubricant sump 4 which is open counter to the rotation direction of the roller sleeve 5 is configured. The lubricant sump 4 is connected by way of supply ducts 6 to the lubricant-water distributor duct 2, through which supply ducts 6 the lubricant is dispensed into the lubricant sump 4.

During operation, the lubricant is extracted from the lubricant sump 4 and is inserted via a flank 7 of the lubricant sump 4 into a lubricating gap 8 which is configured between the roller sleeve 5 and the sealing strip 1. Insertion here takes place on account of the trailing effect of the roller sleeve 5 which entrains the lubricant in the rotation direction and inserts it into the lubricating gap 8, on the one hand, and on account of the suitably selected inclination angle α of the flank 7, which facilitates rising of the lubricant, on the other hand. The angle α here is between 1° and 89°, preferably approx. 45°. In the case of very narrow sealing strips 1, for reasons of technical implementation the value is rather in the range of 15°.

By way of the lubricant sump 4, lubricant is ideally offered in a homogenous manner across the entire width of the sealing strip 1. However, since contaminants often are deposited in the lubricant sump 4, uniform supply of lubricant is not ensured everywhere. In order to address this, it is provided according to the invention that a contamination guard 9, which is channel-shaped, for example, and which displays a square or rectangular cross section which may also dispose of a rounded base, for example, is configured to be milled or otherwise suitably incorporated into the lubricant sump 4.

The contamination guard 9 must display at least one edge in the lubricant sump 4, across which edge the contaminant can place itself. The channel-shaped contamination guard 9, when viewed in the machine direction, should be as narrow as possible here. In order to offer sufficient volume for receiving the contaminants, a depth which is adequate therefor has to be provided.

The contamination guard 9 in its dimensions here is configured so as to be significantly smaller than the lubricant-water sump 4. As a consequence, contaminants which are deposited in the lubricant-water sump 4, on account of their size, cannot make their way into the contamination guard 9 and the lubricant thus flows below them through the channel. On account thereof, a reliable and uninterrupted lubricant deployment from the lubricant sump 4 into the lubricating gap 8 is ensured, on the one hand; the erosion of the deposits stimulates the release and conveyance of the latter from the lubricant sump 4, on the other hand.

The channel-shaped contamination guard 9 is particularly helpful in preventing the drying up between two supply ducts 6. This may occur when a plurality of contaminants place themselves between two supply ducts 6. The most unfavorable case here respectively would be a contamination directly next to a pair of supply ducts 6. Without the contamination guard 9, the entire lubricant sump 4 could dry out on this part, and the sealing strip 1 could be damaged due to the outage of the lubrication. The contamination guard 9 is disposed and dimensioned such that dirt particles are deposited in the lubricant sump 4 but, on account of the modest extent of the channel-shaped contamination guard 9, when viewed in the machine direction, said deposits are merely placed across the edge of said contamination guard 9 and thus form a bridge.

The contamination guard 9 preferably is configured in the lowest region of the lubricant sump 4. The supply ducts 6 in the exemplary embodiment, when viewed in the rotation direction of the roller sleeve 5, open out into the lubricant sump 4 behind the contamination guard 9.

In a similar illustration as in FIG. 1, an enlarged illustration of the upper part of the sealing strip 1 is illustrated in FIG. 2, for reasons of clarity without details of the lubricant supply.

As already described above, adequate lubrication to prevent damage to the sealing strip 1 has to exist at any point in time of the operating period of the sealing strip 1. The lubricant sump 4 is open toward the interior space of the suction roller, resulting in that at all times a spacing x between an overflow edge 10 of the sealing strip 1 and the roller sleeve 5 which should always be greater than 0 has to exist.

If the spacing x is 0, there is contact between the overflow edge 10 of the sealing strip 1 and the roller sleeve 5, which results in damage, since the overflow edge 10 is not being lubricated because the lubricant rises on the flank 7 of the lubricant sump 4 and leaves the overflow edge 10 unwetted. The latter then burns on account of the unlubricated frictional effect between the overflow edge 10 and the suction roller sleeve 5.

Furthermore, experiments have demonstrated that such narrow overflow edges 10 may break off on account of the stresses. The temperature in unlubricated regions increases, in part on account of increased friction. The material here expands, leading to higher stresses. By way of the applied torques and stress concentrations, these regions are increasingly likely to break off.

A so-called run-up angle β substantially describes the same fact as x>0; β thus likewise has always to be greater than 0°. The angle α describes the inclination angle between the flank 7 of the lubricant sump 4 and the overflow edge 10 of the sealing strip 1 in the rotation direction, as has already been mentioned in FIG. 1. Ideally, α is always smaller than 90′; 90° would mean a flank 7 which is perpendicular to the roller sleeve 5. In the case of narrow sealing strips 1 (up to 25 mm width) a is ideally 75°, in the case of wide sealing strips 1 (>35 mm) a is ideally 45° or inclined even more (up to 5°), such that a lubricating wedge which rises to the lubricating gap 8 can be built up.

In the case of narrow construction types, the width of the sealing strip 1 predetermines the maximum possible angle α. Attention has to be paid at all times to the sealing strip 1 displaying a sufficiently wide sealing face, such that sealing is maintained. The minimum sealing face is determined by the bore pattern of the roller sleeve 5. The larger the angle α and thus the inclination of the flank 7, the better the stimulation of the build-up of the lubricating film. Less force has to be applied in order to convey the lubricant to the lubricating gap 8, so as to build up the lubricating film there. It is advantageous here that the rotation speed of the suction roller and of thus the entire fibrous-web machine may be slower.

A bearing length y of the sealing strip 1 on the roller sleeve 5 may under circumstances become so small that at the point in time of the initial installation of the sealing strip 1—that is to say in the new state—said bearing length y describes a linear bearing. This means that only a rear run-off edge 11 of the sealing strip 1 bears on the roller sleeve 5. The possibility thus exists for the largest possible lubricating wedge to be generated, resulting in the best possible, that is to say the lowest, friction losses between the sealing strip 1 and the roller sleeve 5.

A further potential configuration would be to go with a complete curvature, having the radius R, from the lubricant sump 4 to the run-off edge 11 of the sealing strip 1. This results in a continuously decreasing angle α, which is optimal for the build-up of a hydrodynamic lubricating wedge.

In FIG. 3, in a schematic plan view, a further exemplary embodiment of a sealing strip 1 having measures according to the invention for improving the lubrication of the sealing strip 1 and for reducing contaminants is illustrated.

It can be seen in the figure that a plurality of supply ducts 6, which open out into the lubricant sump 4 and which display various diameters, are provided. The diameter here depends on the distance of the respective supply ducts 6 from the lubricant-water supplies 3 to the lubricant-water distributor duct 2 which is configured in the sealing strip 1.

This measure serves the purpose of achieving a uniform pressure distribution in the supply ducts 6. Ideally, the supply ducts 6 are disposed so as to be symmetrical to a lubricant-water supply 3. Those supply ducts 6 which are closest to the lubricant-water supply 3 are smallest in diameter, in order to generate a high loss of pressure here. The diameter of the supply ducts 6 to the lubricant sump 4 also increases as the spacing to the lubricant-water supply 3 increases.

Ideally, the supply duct 6 which lies in the middle between two lubricant supplies 3 has the largest diameter. The bore diameters may vary from 1 mm to 20 mm.

The background to this measure are the effects of various changes in pressure on account of the geometry or fluid engineering, respectively. In the case of small supply ducts 6, the pressure drop is larger than in the case of large supply ducts 6. When viewed across the length of the sealing strip 1, a balanced pressure profile is thus achieved at the respective outlets of the supply ducts 6 into the lubricant sump 4.

Alternatively to the various bore diameters it could also be mentioned here for the sake of completeness that it would likewise be possible for the inboard lubricant distributor duct 2 to be modified in the cross section, in order to obtain the same result—that is to say a homogenous pressure profile at the outlet into the lubricant sump 4 on the outside of the sealing strip 1. The cross-sectional modification of the lubricant distributor duct 2 may be adapted such that the latter interacts with the lubricant supplies 3 of the lubricant provision into the sealing strip 1. If said lubricant supplies 3 are likewise impinged with different pressures, this may be compensated for by way of the cross-sectional modification of the lubricant distributor duct 2.

Alternatively to this variant, a valve which is adapted to the lubricant-water supply 3 into the sealing strip 1 could also be employed. By way of selecting a suitable valve for each of the lubricant-water supplies 3, a homogenous pressure distribution may thus likewise be achieved. In the case of long sealing strips 1, approx. three to five lubricant supplies 3 are meaningful. The various pressures then result from different line lengths or line cross sections, or different angles, respectively, etc.

In FIG. 4, a further exemplary embodiment of the invention is illustrated, likewise in a plan view onto the sealing strip 1.

The variant described in this exemplary embodiment is distinguished by a very simple and cost-effective mode of manufacturing. Simply, a plurality of supply ducts 6 are incorporated in the sealing strip 1, for example by boring, without a lubricant sump 4 which interconnects the supply ducts 6 existing. This variant is also distinguished inter alia in that no contamination can take place, since the supply ducts 6 open out directly from the sealing strip 1. The supply ducts 6 here have a spacing a from one another which may in each case be identical or else variable.

A disadvantage of this variant is that no lubrication takes place on the width a. The spacing a should thus at all times be selected such that, on account of a widening of the lubricating wedge being formed in the lubricating gap 8, a certain overlapping of the lubricant exiting from the individual supply ducts 6 takes place and thus running dry in regions can be largely prevented. The spacing a may vary between 0.5 mm to 500 mm.

If the supply ducts 6 are too close next to one another, a quasi perforation of the sealing strip 1 results, having the disadvantage that the sealing strip 1 is weakened and breaking-off may occur in this region. In order to address this, the supply ducts 6 may have a conical shape which tapers off in a downward manner, as is illustrated in FIG. 4 at bottom right. The supply ducts 6 thus have a modest spacing a on the surface of the sealing strip 1, but larger spacings in the region where the supply ducts 6 open out from the lubricant distributor duct 2. This again leads to an improved rigidity of the sealing strip 1. The diameters at the entry and exit of the supply ducts 6 are to be set in the same size range as in the preceding exemplary embodiment.

In FIG. 5, a further exemplary embodiment of a sealing strip 1 which ensures measures for protection against contamination and for reliable lubrication of the sealing strip 1 during operation is illustrated.

In FIG. 5, the supply ducts 6 according to the invention are disposed in two rows. It would also be conceivable for even more rows to be provided. The supply ducts 6 open out into pockets 12 which assume the function of the lubricant sump 4 according to the exemplary embodiments which have been previously described. The exemplary embodiment has the advantage that the stability of the sealing strip 1 is maintained even when the supply ducts 6 are disposed so as to be close to one another. Here, at least one supply duct 6, or else two or three supply ducts 6, opens out into each of the pockets 12.

As can be seen from FIG. 5, the pockets 12 are disposed in an overlapping manner in the parallel rows, in order to always ensure complete wetting of the sealing-strip surface toward the run-out side. Ideally, the pockets 12 here, in terms of volume, are to be conceived such that the same amount of lubricant water is deployed at any point in time.

The pockets 12 may display arbitrary shapes, elongate-hole-type configurations being preferable here. The walls may be configured so as to be perpendicular or inclined in relation to the surface of the sealing strip 1.

As can be seen below in FIG. 5, the pockets 12 ideally are always disposed toward the overflow edge 10 of the sealing strip 1, and they occupy at least a region which corresponds to half the width of the sealing strip 1 in the rotation direction.

At least one row of the pockets 12, ideally both rows or, in the case of more rows, all rows, are disposed in the region of a flattening of the overflow edge 10, having the angle β, which generates or supports the build-up of the hydrodynamic lubricating wedge, respectively. The rear edge of the pockets 12, in the rotation direction, is thus oriented toward a run-off edge of the sealing strip 1.

In FIG. 6, a further exemplary embodiment of the invention which shows further measures for reducing the tendency toward contamination and for improving the lubricant supply is illustrated.

As already described further above with reference to FIG. 4, the supply ducts here are also configured without an interconnecting lubricant sump 4; they open out directly from the lubricant distributor duct 2 out of the overflow edge 10. Ideally, the overflow edge here again has an angle β of 1° to 89°.

Fan-type clearances 13, which impart a comb-like shape to the surface of the sealing strip 1 are here incorporated in the surface of the sealing strip 1, such that the amount of lubricant exiting from the supply ducts 6 is drawn in the direction of the run-out edge 11 of the sealing strip 1 and, on account of the decreasing spacing to the roller sleeve 5, fans out in the machine cross direction. One clearance 13 may be provided per supply duct 6; however, it is also possible to have a plurality of supply ducts 6 opening out into one clearance 13.

The shape of the clearances 13 here may also be configured using rounded shapes and, in particular, having an edge height of the clearances 13 which flattens.

The invention is not limited to the illustrated exemplary embodiments. In particular, it is possible for the individual features of the invention to be combined with one another.

1-18. (canceled)

19. A sealing strip assembly for sealing a suction box that adjoins a moving roller sleeve of a suction roller in a machine for manufacturing or processing a fibrous web, comprising:
at least one sealing strip disposed to sealingly bear against the moving roller sleeve;
a lubricating device at, on, and/or in said at least one sealing strip for wetting said at least one sealing strip;
said at least one sealing strip having a lubricant sump, said lubricant sump being open counter to a rotation direction of the moving roller sleeve and being connected to said lubricating device; and
a contamination guard disposed in said lubricant sump.

20. The sealing strip according to claim 19, wherein said contamination guard is configured with a channel shape, continuous or with interruptions, and extends substantially across an entire length of said at least one sealing strip.

21. The sealing strip according to claim 19, wherein said contamination guard is disposed to substantially form a lowest point of said lubricant sump.

22. The sealing strip according to claim 19, wherein said lubricant sump is connected to said lubricant supply by way of at least one supply duct.

23. The sealing strip according to claim 19, wherein said at least one supply duct is one of a plurality of supply ducts.

24. The sealing strip according to claim 19, wherein a spacing between an overflow edge of said sealing strip and the roller sleeve is always greater than 0.

25. A sealing strip assembly for sealing a suction box that adjoins a moving roller sleeve of a suction roller in a machine for manufacturing or processing a fibrous web, comprising:
at least one sealing strip disposed to sealingly bear against the moving roller sleeve;
a lubricant distributor duct connected to a lubricant supply for wetting said at least one sealing strip, said lubricant distributor duct being formed at, on, and/or in said at least one sealing strip;
said at least one sealing strip having a lubricant sump formed to open counter to a rotation direction of the moving roller sleeve; and
said at least one sealing strip having supply ducts formed therein, said supply ducts being connected to said lubricant distributor duct and having variable diameters.

26. The sealing strip according to claim 25, wherein a respective diameter of said supply duct depends on a spacing of said supply duct from said lubricant supply.

27. The sealing strip according to claim 26, wherein a diameter of said supply ducts is smallest in a region of an inlet of said at least one lubricant supply into said lubricant distributor duct and increases as a distance to said at least one lubricant supply increases.

28. A sealing strip assembly for sealing a suction box that adjoins a moving roller sleeve of a suction roller in a machine for manufacturing or processing a fibrous web, comprising:
at least one sealing strip disposed to sealingly bear against the moving roller sleeve;
a lubricant distributor duct connected to a lubricant supply for wetting said at least one sealing strip, said lubricant distributor duct being formed at, on, and/or in said at least one sealing strip;
said at least one sealing strip having a lubricant sump, said lubricant sump being open counter to a rotation direction of the moving roller sleeve and being connected to said lubricant supply; and
said sealing strip being formed with supply ducts, said supply ducts being connected to said lubricant distributor duct and being formed at variable spacings from one another.

29. The sealing strip according to claim 28, wherein said spacing of said supply ducts is equal or unequal.

30. The sealing strip according to claim 28, wherein said spacing of said supply ducts lies between 0.5 and 500 mm.

31. The sealing strip according to claim 28, wherein said supply ducts have a conical shape in longitudinal section, which conical shape widening from an outlet out of said lubricant distributor duct to an outlet out of said sealing strip.

32. A sealing strip assembly for sealing a suction box that adjoins a moving roller sleeve of a suction roller in a machine for manufacturing or processing a fibrous web, comprising:
at least one sealing strip disposed to sealingly bear against the moving roller sleeve;
a lubricant supply at, on, and/or in said at least one sealing strip for wetting said at least one sealing strip;
said at least one sealing strip having a lubricant sump, said lubricant sump being open counter to a rotation direction of the moving roller sleeve and being connected to said lubricant supply; and
wherein the means are configured in the form of a lubricant distributor duct which is connected to at least one lubricant supply, characterized in that supply ducts which are configured in the sealing strip and which are connected to the lubricant distributor duct open out from the sealing strip in at least two rows which are substantially parallel with one another.

33. The sealing strip as claimed in claim 31, characterized in that the supply ducts of the at least two rows open out into pockets which are incorporated in a surface of the sealing strip.

34. The sealing strip as claimed in claim 32, characterized in that at least one supply duct opens out into each of the pockets.

35. A sealing strip assembly for sealing a suction box that adjoins a moving roller sleeve of a suction roller in a machine for manufacturing or processing a fibrous web, comprising:
at least one sealing strip disposed to sealingly bear against the moving roller sleeve;
a lubricant distributor duct connected to a lubricant supply for wetting said at least one sealing strip, said lubricant distributor duct being formed at, on, and/or in said at least one sealing strip;
said at least one sealing strip having a lubricant sump, said lubricant sump being open counter to a rotation direction of the moving roller sleeve and being connected to said lubricant supply; and
said sealing strip having supply ducts formed therein, said supply ducts being connected to said lubricant distributor duct and opening out into fan-type clearances in a surface of said sealing strip.

36. The sealing strip according to claim 34, wherein said fan-type clearances widen and/or flatten in an outlet direction of said sealing strip.

37. The sealing strip according to claim 34, wherein said at least one supply duct opens out into each of the fan-type clearances.
